(19) United States
(12) Patent Application Publication
(10) Pub. No.: US 2018/0236349 A1
(43) Pub. Date: Aug. 23, 2018

(54) DIA-STAR

(71) Applicant: Vivian A Armbrester, Lockbourne (PK)

(72) Inventor: Vivian A Armbrester, Lockbourne (PK)

(21) Appl. No.: 15/438,904

(22) Filed: Feb. 22, 2017

(51) Int. Cl. A63F 3/00; G09B 19/22; A63F 11/00; G09B 19/00; A63F 3/04

(52) U.S. Cl. CPC A63F 3/00003; A63F 2003/00943; A63F 11/0074; A63F 3/00697; A63F 11/00; A63F 3/00176; A63F 3/0023; A63F 3/00895; G09B 19/00; A63F 3/0457; A63F 3/0478; A63F 2011/0086; A63F 2003/00747; A63F 2003/00233; G09B 19/22

(57) ABSTRACT

DIA-STAR is a star shaped game board that operates by playing in a clockwise position. All 6 players choose a star game piece, roll the dice and begin moving from the 12:00 position, proceeding towards the right direction. There are various board locations. Each location will direct you what to do. In “Stoney Row” section, you will collect the stones from the area you land in. To win you collect all 12 stones or collect $700. The loser reaches −$300. In “Tribal Parkway” section, you will have to pull a DIA-STAR card and answer or follow instructions. Some of the cards require you to obtain information by Googling on the World Wide Web.

DIA-STAR provides educational information as you make stops along the way. It promotes social interaction, cognitive skills, expands knowledge in science & humanity and encourages further research and studies. Includes easy-to-read instructions.

### TECHNOLOGY

An innovative game board that encourages social interaction and in-depth studies. The players communicate with each other via questions and answers.

This game will also spark the player's interest in the fields of science and theology. It will encourage people to do further in-depth studies. The players can draw inferences from both aspects. Some questions on the DIA-STAR cards require you to utilize the World Wide Web to search and find an answer. This is different than other games boards because it is not just a game it is a resource used to discover educational information and allow players to brainstorm various concepts. This game board involves 2 major areas, the game board and the internet.

### BACKGROUND ART

There are known similar games. One example is that Chinese checkers use a star shaped board that uses marbles or other game pieces to jump over other pieces to win the game. There is no educational part of the game. Google Play has an Internet star game board where the winner is the one who move pieces in to the corner on the opposite side of the board first. This game is played on an android phone. There is no physical board and no educational part of the game.

Chinese Checkers U.S. Pat. No. 1,704,819 A

Shimkorn star shaped game (Google Play)

### BACKGROUND OF INVENTION

Board games are widely known and used around the world to provide entertainment. The first board game called “Royal Game of Ur’ dates back to 2600 B.C. The industry has a diversity of games available but other games are not the same as DIA-STAR. For example MONOPOLY is a real estate game that can take long periods of time to complete. The TRIVIAL PURSUIT game includes questions and answers that require the player to have prior knowledge of several subject areas to be successful in the game. Therefore some players find those games to become less entertaining. The DIA-STAR game provides educational information as the player make stops along the way. To complete this game it does not take an extensive amount of time or require prior knowledge to the game questions. There are 2 ways to win the DIA-STAR game, by either collecting 12 stones or becoming the first player to collect $700 dollars. During this game the players are directed to interact with each other and utilize the World Wide Web. DIA-STAR is educational, entertaining and fun to play.

### SUMMARY OF INVENTION

The object of the DIA-STAR invention is to provide a game board that provides educational information as you make stops along the way on the board locations. It encourages the players to utilize their social interaction skills, cognitive skills and to expand their knowledge in the scientific field. Includes theological information. It sparks the interests of the players to do further research in several areas of studies to broaden their thinking on concepts. DIA-STAR provides a fun way to learn.

Another object of this game is that the players do not need prior knowledge of the game to be successful. Questions are answered and read aloud so that all players can learn as they play.

To fulfill the objectives of this game, the method of playing DIA-STAR is as followed:
(a) A maximum of 6 players can play “DIA-STAR”.
(b) All Players get $300 from the bank before the start of the game.
(c) All Players choose a star game piece. Red, Orange, Yellow, Green, Indigo or Violet.
(d) Place the Player star pieces on the start section above “Tribal Parkway”.
(e) Place the stack of DIA-STAR cards on the board in the designated spot. Below “Tribal Parkway”
(f) To determine the order of play, each Player rolls one dice. The Player that rolls the highest number dice begins first and then next players begin in descending numbers. (e.g.; 6 (first player), 5, 4, 3, 2, 1)
(g) After the order of play is decided the first Player rolls 2 dices and makes the first move across the board towards the “Promise Land”. Moving towards the right direction.
(h) All players take turns rolling dice to play the game and to move across the board.

The game is won when a player collect all 12 stones pieces from “Stoney Row” section OR by becoming the first player to collect $700 dollars. A player can become a loser by becoming disqualified when they borrow $300 dollars or more from the bank. If you are −$300 dollars to the bank you are out of the game.

### BRIEF DESCRIPTION OF DRAWINGS

Each of the game board sections are labeled as a FIGS. 1-9

FIG. 1 illustrates an overview of the Game board

FIG. 2 illustrate the starting point of the game board and where Tribal Parkway resides

FIG. 3 illustrates in this section, where players may pull a DIA-STAR card or follow instructions

FIG. 4 illustrates the section where the Promise Land resides

FIG. 5 illustrates the section where Stoney Row resides. Where players collects stones to win

FIG. 6 illustrates the section where Rainbow Lane resides. Money is collected per location.

FIG. 7 illustrates the last outer region area and where the Pot of Gold resides

FIG. 8 illustrates the inner board area comprised of DIA-STAR cards, “Camp David” and “Abyss” locations. Along the inner part of FIG. 8 the Pot of Gold driveway circumferences the boarder.

FIG. 9 shows an exploded view of the DIA-STAR game board.

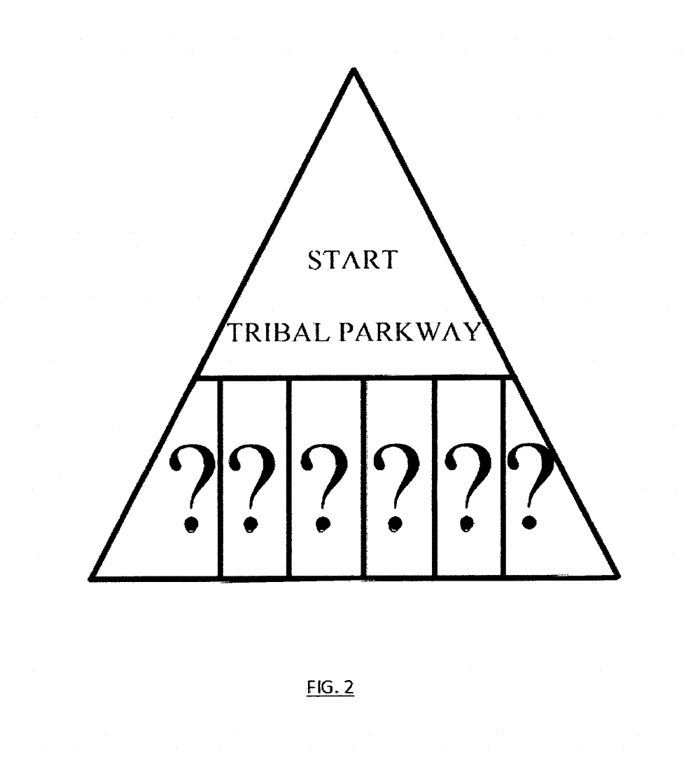

The game is played in clockwise position starting at 12:00 (the FIG. 2 point where Tribal Parkway resides).

### DETAILED DESCRIPTION OF PREFERRED EMBODIMENTS

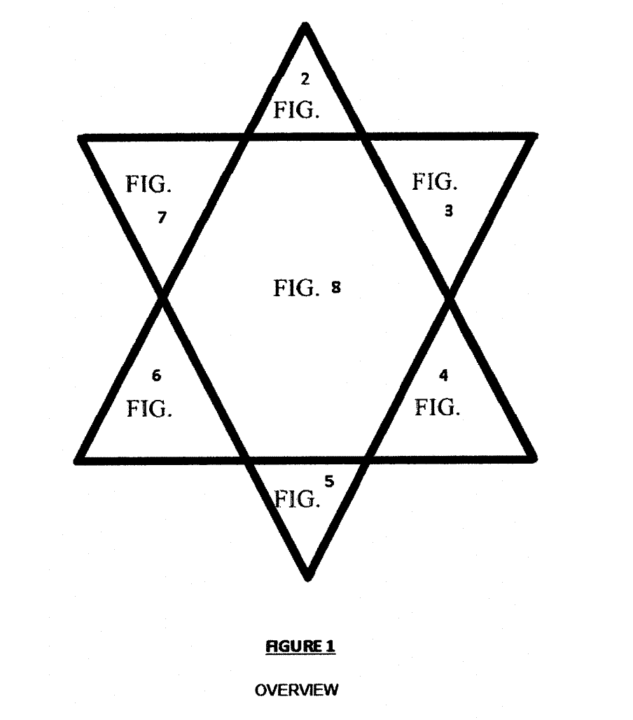

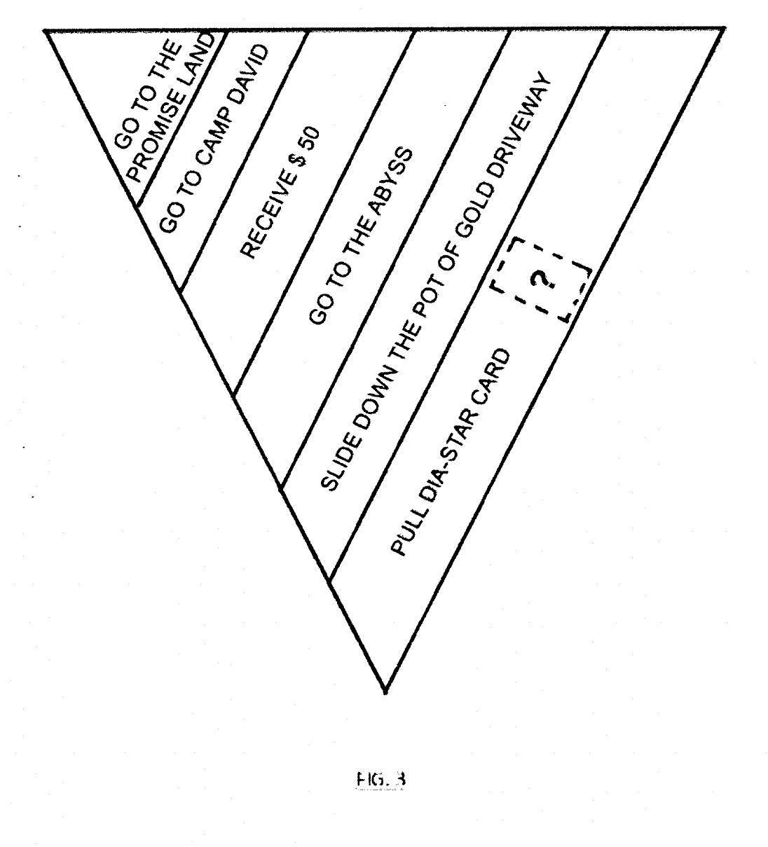

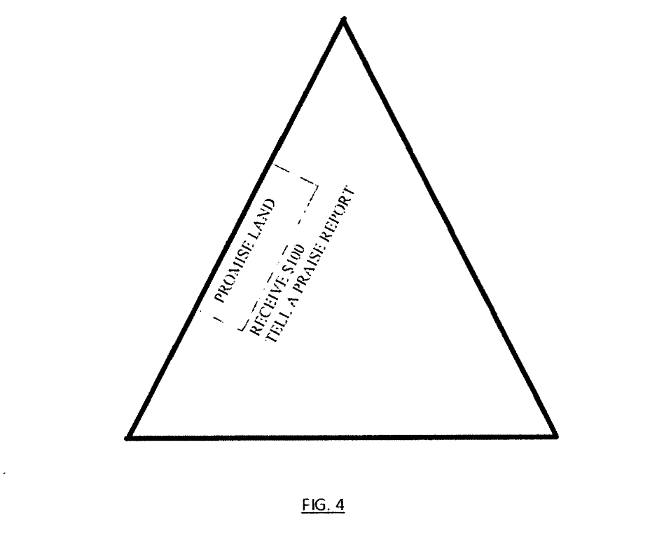

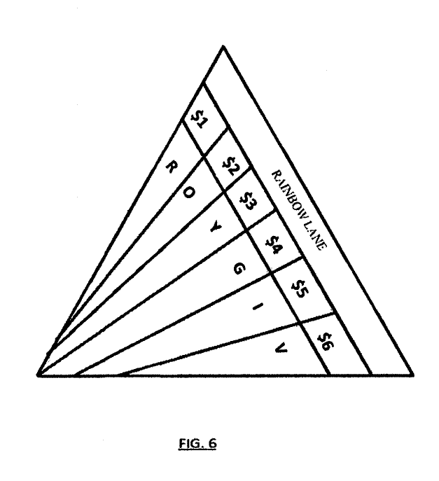

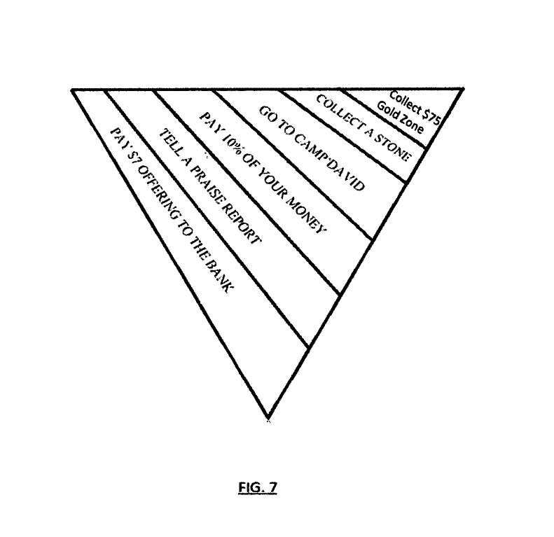

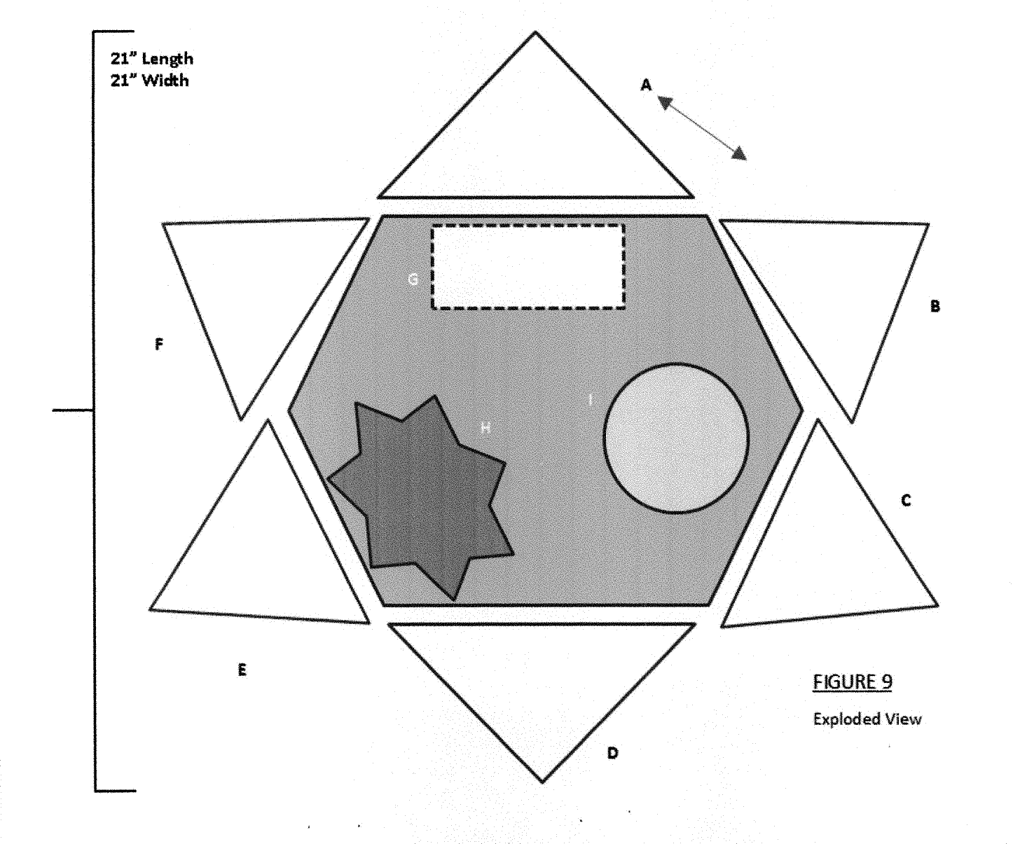

A game board apparatus 1 is illustrated in the drawing that includes FIGS. 1-9. FIG. 1 shows an overview of the game board. 2. This game operates in clockwise position 3. All players start at the 12:00 position illustrated in FIG. 2. 4. There is a section positioned in the top center of the board where the DIA-STAR cards are placed. This includes a selection of random information questions or directions written thereon. 5. Also in the center of the board are 2 locations that the player may be directed to land on. The locations are “Camp David’ and the “Abyss”. 6. On the outer 6 point sections, information is provided within each section of what the player is instructed to do (e.g. collect money, collect a stone, follow directions, pay a fee or pull a DIA-STAR card).

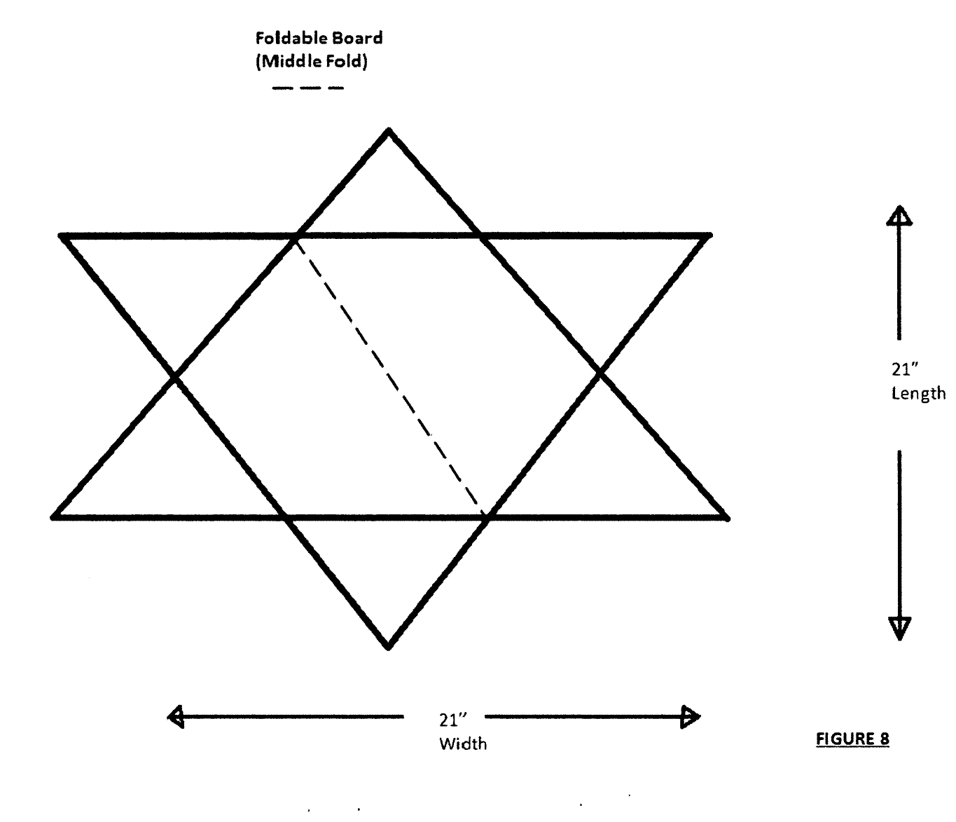

9. The cards that are placed in FIG. 8 section can be easily drawn. The stack of DIA-STAR cards will remain on the board while playing game. When a player is instructed to pull a card after performing instructions on the card it will be placed back in the pile by placing it under the stack. A variety of questions will be available for the player to respond to.

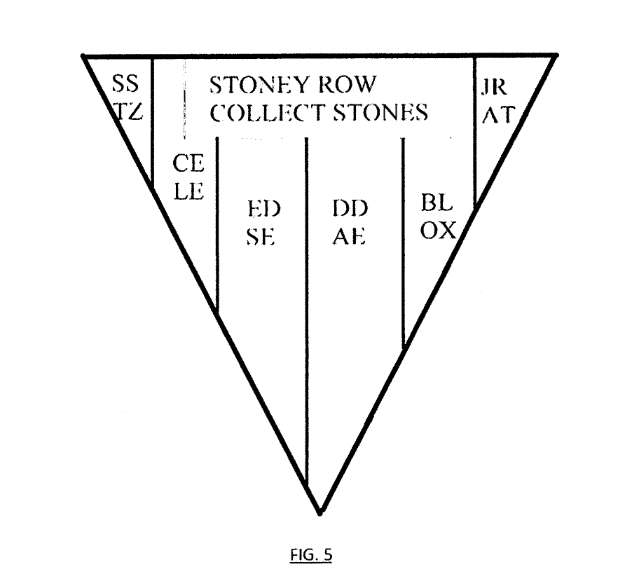

10. In regards to the game pieces: (A) there will be 6 sturdy hard plastic star shaped player pieces. The players will have an option to choose red, orange, yellow green, indigo or violet color pieces. (B) 2 six-sided plastic dice (C) 84 glossy stones with a 2 letter initial written thereon to identify the stone names for collection (e.g. TZ (Topaz). These are collected in the “Stoney Row” section illustrated in FIG. 5. The stones will be color coded per stone (D) Included in the game pieces are a variety of paper money bills.

Prior to the start of the game the order of players is decided. The player that rolls the highest number begins first and then other players begin in descending numbers. (e.g.; 6 (1st player), 5, 4, 3,) After the order of play is decided the first Player rolls 2 dices and makes the first move across the board towards the “Promise Land”. Movement begins towards the right side direction. All players take turns rolling dice to play the game and to advance forward across the board following all instructions and taking all stops that are required.

1. A game apparatus to be used in a game. The game apparatus is comprised of:
A star shaped board made of durable cardboard
Player pieces to hold players location in game
A quantity of cards that have questions or directions printed thereon
Six-sided dice
A quantity of money bills
A quantity of player stone pieces
The player pieces are individually selected by each player. While playing the game the individuals will have an opportunity to select a card to answer a question or be directed to perform a game task. Each player will also participate in the game by collecting money or stone pieces.
Wherein the game ends when a player has collected a predetermined number of 12 stones or by becoming the first player to collect $700 dollars. Thereby being declared the winner.

2. A game apparatus according to claim 1, wherein the player selects a card from a variety of predetermined questions or directions printed thereon with Each card distinctly marked accordingly, and wherein the players have a turn in activities to select from a set of cards.

3. A game apparatus according to claim 2, wherein the player comprises of at least one dice.

4. A game apparatus according to claim 3, further comprising a game board, Wherein the player comprises a selection of contiguous playing spaces positioned on the game board. Each of the playing spaces being distinctly marked to indicate a task to perform and a distinct player piece for each individual. A board that includes marked spaces or areas for players to advance to. These designated sections extend along the 6 outer areas of the board and includes marked spaces within the inner area of the board. Each player will move a player piece forward a number of spaces according to what is shown on at least one dice that is rolled during each players turn.

5. A game apparatus according to claim 1, further comprising a game board.

6. A game board according to claim 5, wherein the games board comprises a predetermined number and type of stone pieces. Wherein each stone piece is distinctly marked according to the name of the stone by a 2 letter indication written thereon. Wherein each stone is further individually color coded. As each player advances forward the player will have the opportunity to collect a stone in the “Stoney Row” section of the game board. The Game board comprises of twelve stone names written thereon. When a player collects all twelve stones first, thus that player is declared the winner. The rules of the game will instruct and advise the players in accordance of the game.

7. A game board according to claim 5, wherein the game board comprises of paper money bills. Wherein each player is distributed a predetermined amount of money at the start of the game. As each player advances forward the player will have the opportunity to collect money When a player collects all $700 first, thus that player is declared the winner.

8. A game board according to claim 1. Further comprising markings on a game board apparatus. The inner sections of a game board include a space marked “Camp David”. As a player advances on the board they can arrive at this location by the roll of at least one dice or by drawing a card and being directed to this location.
In this example of the invention, if you land on “Camp David” you have a 2 day stay. You collect $30 dollars for camping. After 2 missed turns, you can roll the dice and begin moving on the board from the “start” section.

9. A game board according to claim 1. Further comprising markings on a game board apparatus. The inner sections of a game board include a space marked “Abyss”. As a player advances on the board they can arrive at this location by the roll of at least one dice or by drawing a card and being directed to this location.
In this example of the invention, if you land on “Abyss” you have a 3 day stay. You pay a $100 dollar penalty to the bank for the 3 day stay. You miss 3 turns. You can roll the dice during the stay to get out. If you roll a double you can get out and begin moving from the “start” section.

10. A game apparatus according to claim 2, further comprising a game board. When a player is instructed to select a card, during the selection process, the player may randomly select a card that directs them to interact with the Internet. This will require the player to follow the directions written thereon the selected card.

11. A game apparatus according to claim 1, further comprising a game board. a player can become disqualified if the player borrows $300 dollars or more from the bank. If a player is −$300 dollars to the bank, that player is out of the game.
The rules of the game will instruct and advise the players in accordance of the game. Players will be further compelled during the game, by the directions written thereon the Board or by the written instructions that are thereon each selected card.
